(19) United States
(12) Patent Application Publication
(10) Pub. No.: US 2009/0147722 A1
(43) Pub. Date: Jun. 11, 2009

(54) METHOD AND DEVICE FOR TRANSMITTING A DATA PACKET IN A WIRELESS COMMUNICATION NETWORK USING BANDWIDTH OCCUPANCY COST FACTORS

(75) Inventor: Shyamal Ramachandran, Lake Mary, IL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/950,557

(22) Filed: Dec. 5, 2007

(51) Int. Cl. H04B 7/14

(52) U.S. Cl. 370/315

(57) ABSTRACT

A method for transmitting a data packet from a source node to a destination node in a wireless communication network as provided enables bandwidth aware path selection. The method includes determining a first link metric using a first bandwidth occupancy cost factor for a first multi-hop path between the source node and the destination node. Next, a second link metric is determined using a second bandwidth occupancy cost factor for a second multi-hop path between the source node and the destination node. It is then determined whether the first multi-hop path or the second multi-hop path is a preferred path based on a comparison of the first link metric and the second link metric. Finally, the data packet is transmitted from the source node to the destination node over the preferred path.

### FIELD OF THE INVENTION

The present invention relates generally to wireless communication networks, and in particular to transmitting a data packet from a source node to a destination node by determining link metrics using bandwidth occupancy cost factors.

### BACKGROUND

Many wireless communication systems require a rapid deployment of independent mobile users as well as reliable communications between user nodes. Mesh networks, such as Mobile Ad Hoc Networks (MANETs), are based on self-configuring autonomous collections of portable devices that communicate with each other over wireless links having limited bandwidths. A mesh network is a collection of wireless nodes or devices organized in a decentralized manner to provide range extension by allowing nodes to be reached across multiple hops. In a mesh network, communication packets sent by a source node thus can be relayed through one or more intermediary nodes before reaching a destination node. Thus mesh networks may be deployed as temporary packet radio networks that do not involve significant, if any, supporting infrastructure. Rather than employing fixed base stations, in some mesh networks each user node can operate as a router for other user nodes, enabling expanded network coverage that can be set up quickly, at low cost, and which is highly fault tolerant.

Mesh networks can provide critical communication services in various environments involving, for example, emergency services supporting police and fire personnel, military applications, industrial facilities and construction sites. Mesh networks are also used to provide communication services in homes, in areas with little or no basic telecommunications or broadband infrastructure, and in areas with demand for high speed services (e.g., universities, corporate campuses, and dense urban areas). Routing communications between two nodes in a static network generally involves simply determining the shortest route between the two nodes. However, in a mesh network, the determination of an optimal communication route may involve additional factors. For example, propagation path losses, interference between users, and channel fading may require the use of an indirect route between two nodes in order to provide an acceptable Quality of Service (QoS) to the network users.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a diagram illustrating a basic mesh network, according to the prior art.

FIG. 2 is a table illustrating how each of a single spatial stream, 40 Mega Hertz (MHz) bandwidth data rates falls in between two adjacent double spatial stream, 20 MHz bandwidth data rates, according to a conventional IEEE 802.11n mesh network of the prior art.

FIG. 3 is a diagram illustrating a mesh network, according to some embodiments of the present invention.

FIG. 4 is a graph illustrating a comparison of link metrics versus packet completion rates for a single stream, binary phase shift keying (BPSK) one-half modulation (denoted as MCS0) over a 40 MHz channel, and a two stream, BPSK one-half modulation (denoted as MCS8) over a 20 MHz channel, according to the prior art.

FIG. 5 is a graph illustrating a comparison of link metrics versus packet completion rates for various transmission data rates of two spatial stream, 20 MHz modes and one spatial stream, 40 MHz modes, according to the prior art.

FIG. 6 is a graph illustrating a comparison of bandwidth aware link metrics versus packet completion rates for a single stream, BPSK one-half modulation (MCS0) over a 40 MHz channel, and a two stream, BPSK one-half modulation (MCS8) over a 20 MHz channel, according to some embodiments of the present invention.

FIG. 7 is a graph illustrating a comparison of bandwidth aware link metrics versus packet completion rates for various other transmission data rates of the two stream, 20 MHz modes and one stream, 40 MHz modes, according to some embodiments of the present invention.

FIG. 8 is a general flow diagram illustrating a method for transmitting a data packet from a source node to a destination node in a mesh network, according to some embodiments of the present invention.

FIG. 9 is a block diagram illustrating device components of a mesh network node in a mesh network, according to some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to transmitting a data packet in a wireless communication network using bandwidth occupancy cost factors. Accordingly, the apparatus components and method steps have been represented where appropriate by conventional symbols in the drawings, showing only those specific details that are pertinent to understanding the embodiments of the present invention, so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of transmitting a data packet in a wireless communication network using bandwidth occupancy cost factors as described herein. The non-processor circuits may include, but are not limited to, a radio receiver, a radio transmitter, signal drivers, clock circuits, power source circuits, and user input devices. As such, these functions may be interpreted as steps of a method for transmitting a data packet in a wireless communication network using bandwidth occupancy cost factors. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Any embodiment described herein is not necessarily to be construed as preferred or advantageous over other embodiments. All of the embodiments described in this Detailed Description are illustratively provided to enable persons skilled in the art to make or use the invention and not to limit the scope of the invention which is defined by the claims.

According to one aspect, some embodiments of the present invention define a method for transmitting a data packet from a source node to a destination node in a wireless communication network, where the method enables a bandwidth aware path selection. The method includes determining a first link metric using a first bandwidth occupancy cost factor for a first multi-hop path between the source node and the destination node. Next, a second link metric is determined using a second bandwidth occupancy cost factor for a second multi-hop path between the source node and the destination node. It is then determined whether the first multi-hop path or the second multi-hop path is a preferred path based on a comparison of the first link metric and the second link metric. Finally, the data packet is transmitted from the source node to the destination node over the preferred path. The method thus explicitly considers excess bandwidth used on links between network nodes and an available usable bandwidth in a frequency band of operation.

According to the prior art, generic link metrics used in mesh networks do not consider the cost of radio frequency (RF) channel bandwidth used over network links. Rather, such generic metrics assume monotonically increasing data rates and only one operational bandwidth. However, with the advent of newer devices such as Institute of Electrical and Electronics Engineers (IEEE) 802.11n radios, these assumptions are no longer true. (Any of the IEEE standards or specifications referred to herein may be obtained at http://standards.ieee.org/getieee802/index.html or by contacting the IEEE at IEEE, 445 Hoes Lane, PO Box 1331, Piscataway, N.J. 08855-1331, USA.) The IEEE 802.11n standard allows higher data rate transmissions using various mechanisms: by maintaining a same operational bandwidth and increasing the number of spatially multiplexed streams, by maintaining the same number of spatially multiplexed streams and increasing the operational bandwidth, or by doing both. When modes where the operational bandwidth is increased, additional radio frequency (RF) channel resources are consumed.

Therefore, according to some embodiments of the present invention, a new link metric is defined that explicitly considers excess bandwidth used on links, and the available usable bandwidth in an RF band of operation. Thus the cost of using a certain bandwidth over different paths can be measured, and a preferred path can be determined accordingly.

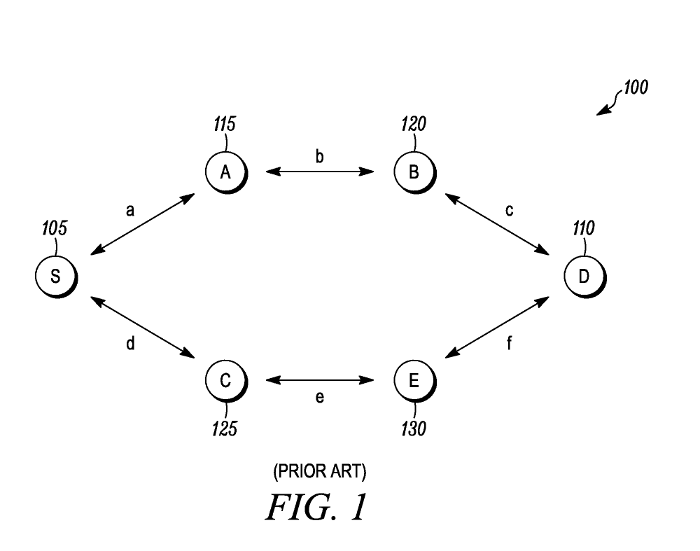

Referring to FIG. 1, a diagram illustrates a basic mesh network 100, according to the prior art. Nodes in a typical mesh network use end-to-end path metrics to select a path from multiple path options to any destination. The path metrics are generally a sum of individual link metrics along a particular path. For example, the network 100 comprises a source S node 105, a destination D node 110, and the following intermediate nodes: A node 115, B node 120, C node 125, and E node 130. The S node 105 thus has two path options to reach the destination D node 110: 1) a path along S-A-B-D and 2) a path along S-C-E-D. Individual wireless link metrics along the paths are identified by the letters a through f. A total path metric is generally the sum of individual link metrics along the path, such the sum of link metrics a+b+c, and the sum of link metrics d+e+f.

Link metrics used in prior art mesh networks generally depend on one or more of a link data rate, a packet size, an overhead time and the link's frame error rate. For example, an expected transmission count (ETX) link metric depends on the expected number of transmissions required on the link. A description of such an ETX metric is provided in Douglas S. J. De Couto, Daniel Aguayo, John Bicket, and Robert Morris; A High-Throughput Path Metric for Multi-Hop Wireless Routing; Proceedings of the 9th ACM International Conference on Mobile Computing and Networking (MobiCom '03), San Diego, Calif., September 2003. An expected transmission time (ETT) link metric depends on the expected transmission time across a link. A description of such an ETT link metric is provided in R. Draves, J. Padhye, and B. Zill; Routing in Multi-radio, Multi-hop Wireless Mesh Networks; ACM MobiCom, Philadelphia, Pa., September 2004.

Other types of mesh networks use a link metric that depends on packet size, data rate, frame error rate, total transmission air time and overhead time. A description of such a link metric is provided in United States Patent Application Publication No. US 2006/0109787 A1, to Strutt et al, titled “System and Method for Providing a Congestion-Aware Routing Metric for Selecting a Route Between Nodes in a Multihopping Communication Network”, published on May 25, 2006, and herein incorporated by reference in its entirety.

The above described metrics of the prior art generally attempt to quantify how quick and reliable are transmissions over a given link. A general philosophy of path selection, based on such metrics, is therefore to select links with a higher data rate as long as the links are sufficiently reliable. However, such prior art link metrics do not explicitly address bandwidth efficiency. It is assumed that the higher the data rate, the more bandwidth efficient the system and therefore the lower the metric. According to the prior art, bandwidth efficiency increases with data rate, because prior art radios generally transmit over fixed RF bandwidth (for example, 20 MHz) throughout a mesh network.

However, IEEE 802.11n radios have 20 MHz and 40 MHz modes. An IEEE 802.11n radio can thus change its transmission bandwidth per packet per destination. The transmission data rates of a single spatial stream (denoted as Nss=1) in a 40 MHz bandwidth mode are comparable to two spatial streams (denoted as Nss=2) in a 20 MHz bandwidth mode. Generally, the Nss=2, bandwidth (BW)=20 MHz rates and the Nss=1, BW=40 MHz data rates are perfectly staggered, and the data rates of the latter mode are marginally higher.

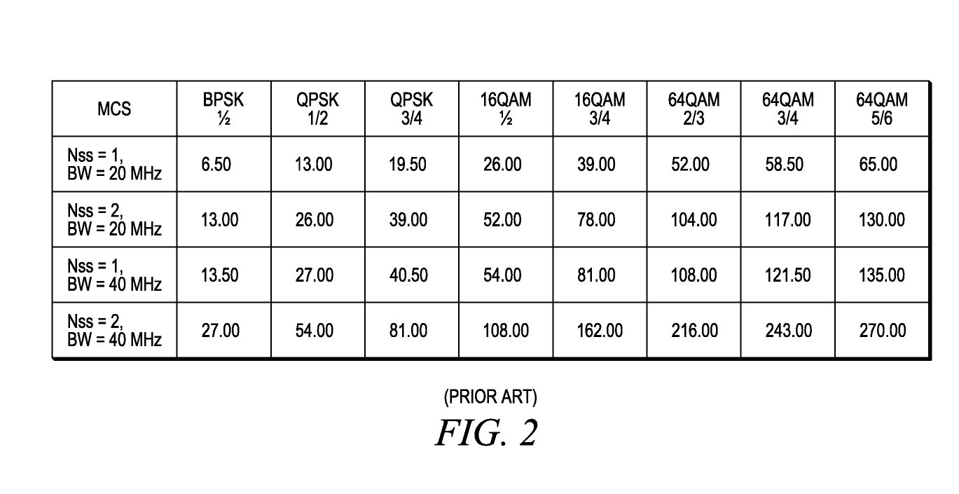

Referring to FIG. 2, a table illustrates how each of the Nss=1, BW=40 MHz data rates falls in between two adjacent Nss=2, BW=20 MHz data rates, according to a conventional IEEE 802.11n mesh network of the prior art. The modulation and coding schemes (MCS) analyzed include binary phase shift keying (BPSK), quadrature phase shift keying (QPSK), and 16 and 32 state quadrature amplitude modulation (QAM). For a given MCS, if all else is equal, the [Nss=2, 20 MHz] spatial multiplexing mode has a 3 decibel (dB) more stringent link budget than the [Nss=1, 40 MHz] mode. Therefore when a link is deployed for the [Nss=2, 20 MHz] mode (the more stringent of the two modes) the [Nss=1, 40 MHz] mode will deliver lower frame error rates. From a transmission air time perspective, the two modes deliver very similar air transmission times. The specific data rates of the [Nss=1, 40 MHz] mode are actually slightly higher and therefore result in slighter lower transmission air time.

Since both frame error rate and transmission air time favor the [Nss=1, 40 MHz] mode, all of the above mentioned metrics will lead to the selection of paths that operate on a 40 MHz bandwidth as opposed to a 20 MHz bandwidth. Detrimentally, as described below, the cost trade-off of using a wider bandwidth can be significant.

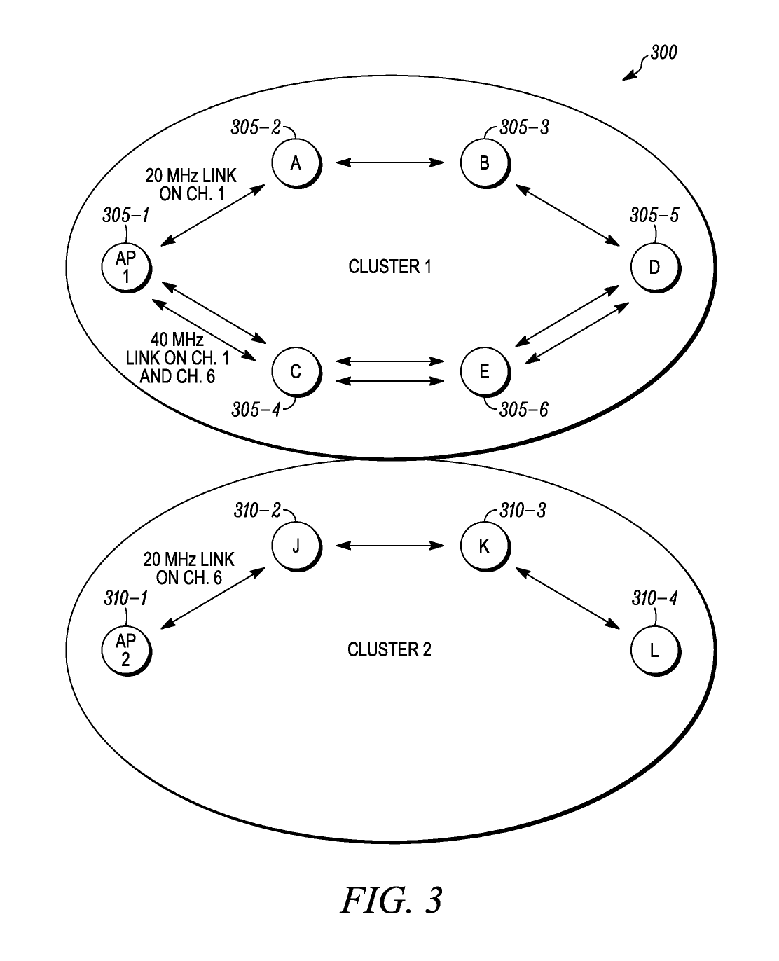

Referring to FIG. 3, a diagram illustrates a mesh network 300, according to some embodiments of the present invention. The following example illustrates the benefits of explicitly accounting for the cost incurred in using the IEEE 802.11n [Nss=1, 40 MHz] mode in the mesh network 300. The network 300 comprises an access point (AP) AP1 node 305-1, A node 305-2, B node 305-3, C node 305-4, D node 305-5, and E node 305-6, all of which are located in a cluster 1 and are mainly operating on a radio frequency (RF) Channel 1. Additionally, an AP2 node 310-1, J node 310-2, K node 310-3 and L node 310-4 are in located in a cluster 2 and are mainly operating on an RF Channel 6. All nodes are IEEE 802.11n compliant and support 40 MHz operation modes.

In cluster 1, the D node 305-5 has the option of two paths to the AP1 node 305-1. The path D-B-A-AP1 operates on links that are capable of supporting the [Nss=2, 20 MHz] mode data rates. The other path D-E-C-AP1 operates on links that are not capable of supporting two spatial streams but can support similar high data rates using the [Nss=1, 40 MHz] mode data rates. Thus the D node 305-5 must determine which path is a preferred path.

The generally used link metrics listed above do not adequately differentiate between the two paths shown in cluster 1. That is because the data rates along the two paths are very similar and the frame error rates are also similar and very low.

For example, one of the above mentioned generally used link metrics is the metric described in United States Patent Application Publication No. US 2006/0109787 A1, referenced above, and is defined by the following Equation 1:

$$M = α \cdot {\sum }_{h = 1}^{H} \frac{{t}_{s} \{ d r ( h ) , L ( h ) \} + {t}_{e}}{P C R ( h ) \cdot L ( h )} \qquad ( Eq . 1 )$$

where
L(h) is a reference (or average) packet size at hop h;
tₛ is a total transmit time, including overhead, as a function of data rate and packet size;
tₑ is time spent in backoffs as a result of erroneous transmissions;
dr(h) is the average data rate at hop h;
PCR(h) is the packet completion at hop h; and

α is a scaling factor.

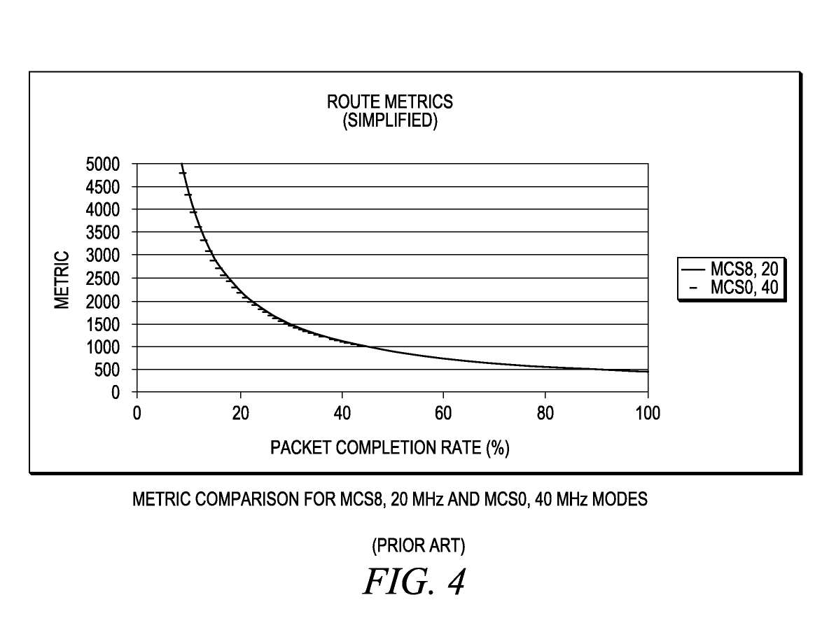

Referring to FIG. 4, a graph illustrates a comparison of metrics calculated using Eq. 1 versus packet completion rates (also known in the art as frame success rates) for a single spatial stream, BPSK one-half modulation (denoted as MCS0) over a 40 MHz channel, and a two spatial stream, BPSK one-half modulation (denoted as MCS8) over a 20 MHz channel, according to the prior art. As shown, the former results in a data rate of 13.5 Mega Bits Per Second (Mbps) and the latter results in a data rate of 13 Mbps. Thus there is little difference between the two schemes.

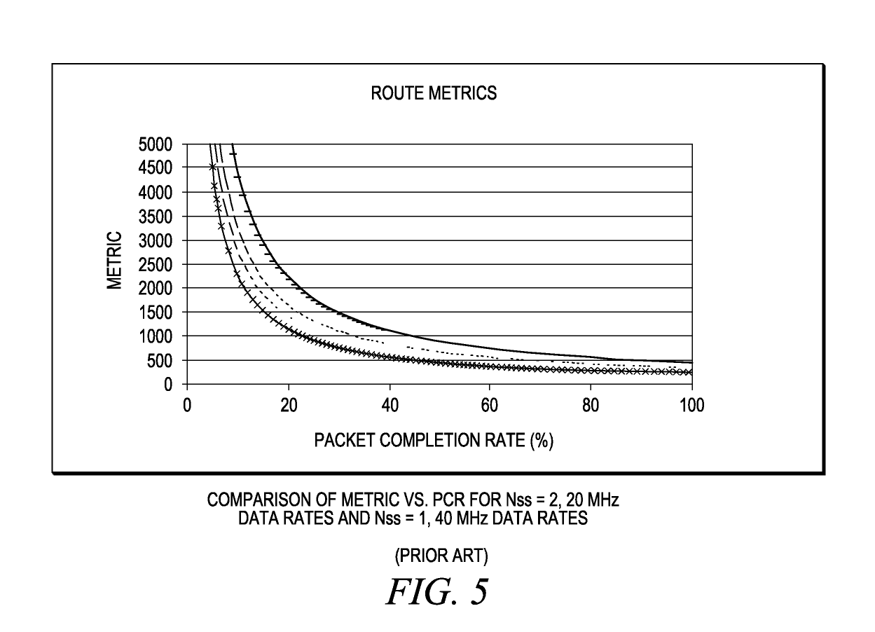

Referring to FIG. 5, a graph illustrates a comparison of metrics calculated using Equation 1 versus packet completion rates for various transmission data rates of the two stream, 20 MHz modes and one stream, 40 MHz modes, according to the prior art. As shown, the resulting metrics for the various data rates are again very similar.

Therefore, based on Equation 1, the D node 305-5 might treat both path options equally and might mistakenly select the path D-E-C-AP1, which operates on the single stream, 40 MHz mode. However, for the mesh network 300, that selection is clearly sub-optimal, since the mesh network 300 is a multi-frequency network and RF Channel 6 is in use in Cluster 2. Thus selecting the path D-E-C-AP1 will adversely impact the bandwidth efficiency of the mesh network 300. Nevertheless, such a selection is not discouraged according to the prior art, because the metric defined in Equation 1 does not incorporate the cost of using wider bandwidths.

According to some embodiments of the present invention, it is therefore useful to incorporate the cost of using wider bandwidths in frequency planned, multi frequency mesh networks. For example, an improved air time based link metric can incorporate the following factors:
BWₘᵢₙ—A minimum required transmission bandwidth. For example, for IEEE 802.11n radios, this value is 20 MHz.
BW—Actual link transmission bandwidth. For example, for IEEE 802.11n radios, this value can be 20 MHz or 40 MHz.
BW_{band}—Total available bandwidth in band. This is the total bandwidth of all usable, non-overlapping channels in a band of operation. For example, in the 2.4 GHz Industrial, Scientific and Medical (ISM) band, this is 60 MHz.

Using the above factors, a bandwidth occupancy cost factor can be calculated by the following Equation 2:

$$BW\_Occupancy \_Cost \_Factor = [ 1 + \frac{β ( B W - B {W}_{min} )}{B {W}_{band}} ] \qquad ( Eq . 2 )$$

where β is a scaling factor.

Equation 2 includes excess bandwidth spent over a link by the numerator term BW−BWₘᵢₙ. Additionally, Equation 2 also includes the total available usable channel space or spectrum in a band of operation. Thus, using these two parameters, a cost of using a wider bandwidth link option over a narrower bandwidth option is quantified more clearly. As excess bandwidth used increases, the BW_Occupancy_Cost_Factor also increases. Further, as the total available bandwidth in a band of operation is increased, the BW_Occupancy_Cost_Factor decreases.

The BW_Occupancy_Cost_Factor defined in Equation 2 can be applicable to various generally used link metrics, including those listed above. For example, applying the BW_Occupancy_Cost_Factor of Equation 2 to the cost Metric from Equation 1 provides a Bandwidth Aware Cost Metric (M_{BW}) as shown in the following Equation 3:

$${M}_{B W} = α \cdot {\sum }_{h = 1}^{H} \frac{{t}_{s} \{ d r ( h ) , L ( h ) \} + {t}_{e}}{P C R ( h ) \cdot L ( h )} \times [ 1 + \frac{β ( B W - B {W}_{min} )}{B {W}_{band}} ] \qquad ( Eq . 3 )$$

For example, consider the application of the M_{BW} metric of Equation 3 to the path selection problem illustrated in the mesh network 300 as shown in FIG. 3. Because the mesh network 300 is IEEE 802.11n compliant, its BWₘᵢₙ=20 MHz, as that is the minimum bandwidth supported by the standard. Assuming operation in the 2.4 GHz ISM band, BW_{band}=60 MHz, as there are three non-overlapping channels. Based on the above description of the mesh network 300, BW=20 MHz for the path D-B-A-AP1, and BW=40 MHz for the path D-E-C-AP1.

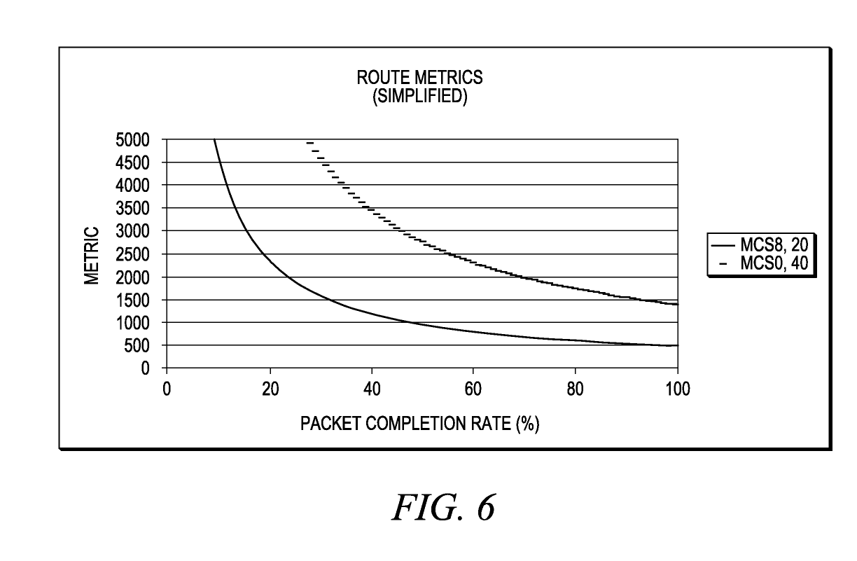

Referring to FIG. 6, a graph illustrates a comparison of M_{BW} metrics calculated using Equation 3 versus packet completion rates for a single stream, BPSK one-half modulation (MCS0) over a 40 MHz channel, and a two stream, BPSK one-half modulation (MCS8) over a 20 MHz channel, according to some embodiments of the present invention. As shown, the former results in a data rate of 13.5 Mbps and the latter results in a data rate of 13 Mbps. However, despite the very similar data rates, and compared with the M metric illustrated in FIG. 4, the M_{BW} metric illustrated in FIG. 6 emphasizes the actual difference between the two schemes resulting from use of excess channel bandwidth.

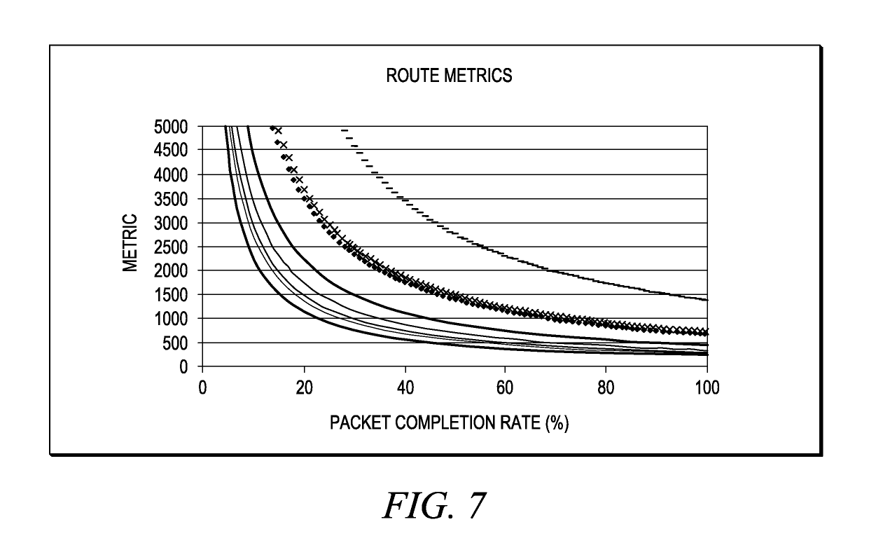

Referring to FIG. 7, a graph illustrates a comparison of metrics calculated using Equation 3 versus packet completion rates for various other transmission data rates of the two stream, 20 MHz modes and one stream, 40 MHz modes, according to some embodiments of the present invention. When compared with FIG. 5, the M_{BW} metric is able to better differentiate between the two modes by incorporating a bandwidth occupancy cost factor.

Thus some embodiments of the present invention provide a bandwidth aware link metric that explicitly considers excess bandwidth used in mesh network wireless links and an available usable bandwidth in an RF band of operation. Relative costs of using a certain bandwidth over different paths therefore can be calculated.

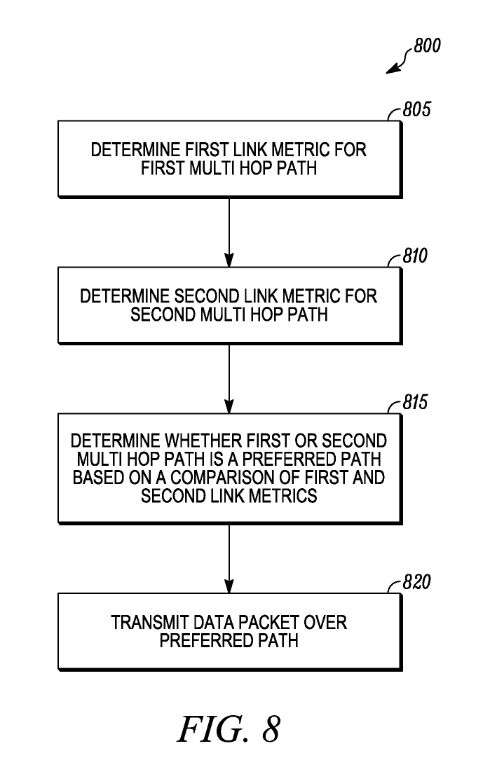

Referring to FIG. 8, a general flow diagram illustrates a method 800 for transmitting a data packet from a source node to a destination node in the mesh network 300, according to some embodiments of the present invention. At step 805, a first link metric using a first bandwidth occupancy cost factor is determined for a first multi-hop path between the source node and the destination node. For example, a first link metric using Equation 3 is calculated for the path D-E-C-AP1, which is a single stream, BPSK one-half modulation (MCS0) over a 40 MHz channel path. A complete first path metric for the path D-E-C-AP1 is determined by using the first link metric.

At step 810, a second link metric using a second bandwidth occupancy cost factor is determined for a second multi-hop path between the source node and the destination node. For example, a second link metric using Equation 3 is calculated for the path D-B-A-AP1, which is a two stream, BPSK one-half modulation (MCS8) over a 20 MHz channel path. A complete second path metric for the path D-B-A-AP1 is determined by using the second link metric.

At step 815, it is then determined whether the first multi-hop path or the second multi-hop path is a preferred path based on a comparison of the first link metric and the second link metric. As will be understood by those having ordinary skill in the art, the comparison of the first link metric and the second link metric is performed indirectly by comparing the complete first path metric (which includes the first link metric) and the complete second path metric (which includes the second link metric). For example, as shown in FIG. 6, because the M_{BW} of Equation 3 is higher for path D-E-C-AP1, it is determined that path D-B-A-AP1 is a preferred path. Step 815 can thus include determining a first multi-hop path total metric using a plurality of link metrics including the first link metric; determining a second multi-hop path total metric using a plurality of link metrics including the second link metric; and then comparing the first multi-hop path total metric and the second multi-hop path total metric.

At step 820, the data packet from the source node is transmitted to the destination node over the preferred path. For example, the D node 305-5 transmits a data packet to the AP1 node 305-1 over the path D-B-A-AP1.

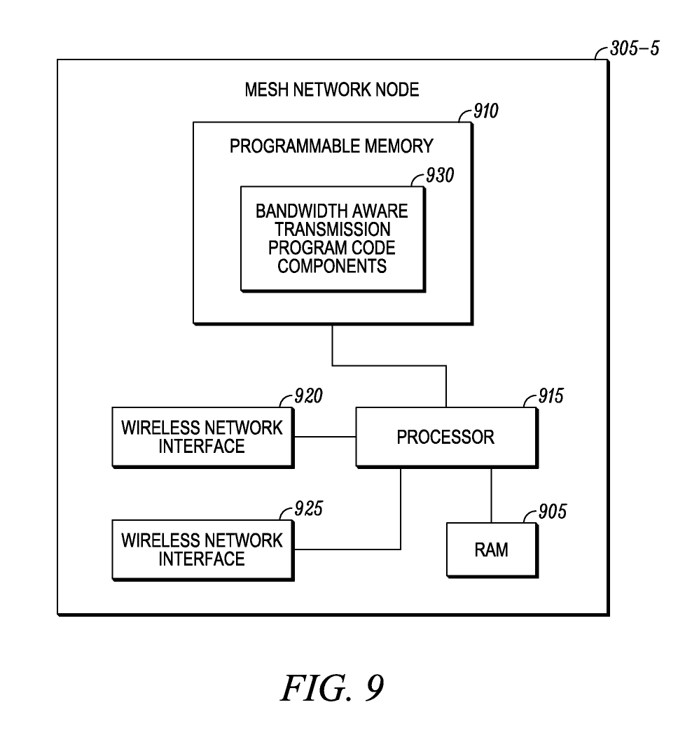

Referring to FIG. 9, a block diagram illustrates device components of the D node 305-5 in the mesh network 300, according to some embodiments of the present invention. The D node 305-5 comprises a random access memory (RAM) 905 and a programmable memory 910 that are coupled to a processor 915. The processor 915 also has ports for coupling to network interfaces 920, 925, which may comprise wired or wireless interfaces.

The network interfaces 920, 925 can be used to enable the D node 305-5 to communicate with neighboring network nodes in the mesh network 300. For example, the network interface 920 can be used to receive and send data packets from and to, respectively, the AP1 node 305-1 over the path D-B-A-AP1.

The programmable memory 910 can store operating code (OC) for the processor 915 and code for performing functions associated with the D node 305-5. For example, the programmable memory 910 can comprise computer readable program code components 930 configured to cause execution of a bandwidth aware method for transmitting a data packet from a source node to a destination node in a wireless communication network as described herein.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims as issued.

We claim:

1. A method for transmitting a data packet from a source node to a destination node in a wireless communication network, the method comprising:
determining a first link metric using a first bandwidth occupancy cost factor for a first multi-hop path between the source node and the destination node;
determining a second link metric using a second bandwidth occupancy cost factor for a second multi-hop path between the source node and the destination node;
determining whether the first multi-hop path or the second multi-hop path is a preferred path based on a comparison of the first link metric and the second link metric; and
transmitting the data packet from the source node to the destination node over the preferred path.

2. The method of claim 1, wherein determining whether the first multi-hop path or the second multi-hop path is a preferred path based on a comparison of the first link metric and the second link metric comprises:
determining a first multi-hop path total metric using a plurality of link metrics including the first link metric;
determining a second multi-hop path total metric using a plurality of link metrics including the second link metric; and
comparing the first multi-hop path total metric and the second multi-hop path total metric.

3. The method of claim 1, wherein the first bandwidth occupancy cost factor is determined using a bandwidth of the first multi-hop path and the second bandwidth occupancy cost factor is determined using a bandwidth of the second multi-hop path.

4. The method of claim 1, wherein the first bandwidth occupancy cost factor and the second bandwidth occupancy cost factor are determined using a minimum required bandwidth.

5. The method of claim 1, wherein the first bandwidth occupancy cost factor and the second bandwidth occupancy cost factor are determined using a total available bandwidth.

6. The method of claim 1, wherein the first link metric is a function of the first bandwidth occupancy cost factor and a factor including parameters selected from the following group: a reference packet size; a total transmit time as a function of data rate and packet size; a time spent in back-offs as a result of erroneous transmissions; an average data rate; a packet completion rate; and a scaling factor.

7. The method of claim 1, wherein the first bandwidth occupancy cost factor and the second bandwidth occupancy cost factor are determined according to the following equation:
$$BW\_Occupancy \_Cost \_Factor = [ 1 + \frac{β ( B W - B {W}_{min} )}{B {W}_{band}} ]$$
where BWₘᵢₙ is a minimum required transmission bandwidth; BW is an actual link transmission bandwidth; BW_{band} is a total available bandwidth; and β is a scaling factor.

8. The method of claim 7, wherein the minimum required transmission bandwidth is 20 MHz, the actual link transmission bandwidth is either 20 MHz or 40 MHz, and the total available bandwidth is 60 MHz.

9. The method of claim 7, wherein the first link metric and the second link metric are determined according to the following equation:
$${M}_{B W} = α \cdot {\sum }_{h = 1}^{H} \frac{{t}_{s} \{ d r ( h ) , L ( h ) \} + {t}_{e}}{P C R ( h ) \cdot L ( h )} \times [ 1 + \frac{β ( B W - B {W}_{min} )}{B {W}_{band}} ]$$
where M_{BW} is the first or second link metric; L(h) is a reference packet size at hop h; tₛ is a total transmit time as a function of data rate and packet size; tₑ is a time spent in back-offs as a result of erroneous transmissions; dr(h) is an average data rate at hop h; PCR(h) is a packet completion rate at hop h; and α is a scaling factor.

10. The method of claim 1, wherein the first link metric and the second link metric are determined using either an expected transmission count (ETX) link metric or an expected transmission time (ETT) link metric.

11. The method of claim 1, wherein at least one link in either the first multi-hop path or the second multi-hop path can transmit the data packet using space-division multiplexing.

12. The method of claim 1, wherein at least one node in either the first multi-hop path or the second multi-hop path transmits data packets using an Institute of Electrical and Electronics Engineers (IEEE) 802.11n technology.

13. A device for transmitting a data packet from a source node to a destination node in a wireless communication network, comprising:
computer readable program code components for determining a first link metric using a first bandwidth occupancy cost factor for a first multi-hop path between the source node and the destination node;
computer readable program code components for determining a second link metric using a second bandwidth occupancy cost factor for a second multi-hop path between the source node and the destination node;
computer readable program code components for determining whether the first multi-hop path or the second multi-hop path is a preferred path based on a comparison of the first link metric and the second link metric; and
computer readable program code components for transmitting the data packet from the source node to the destination node over the preferred path.

14. The device of claim 13, wherein the computer readable program code components for determining whether the first multi-hop path or the second multi-hop path is a preferred path based on a comparison of the first link metric and the second link metric comprise:
computer readable program code components for determining a first multi-hop path total metric using a plurality of link metrics including the first link metric;
computer readable program code components for determining a second multi-hop path total metric using a plurality of link metrics including the second link metric; and
computer readable program code components for comparing the first multi-hop path total metric and the second multi-hop path total metric.

15. The device of claim 13, wherein the first bandwidth occupancy cost factor is determined using a bandwidth of the first multi-hop path and the second bandwidth occupancy cost factor is determined using a bandwidth of the second multi-hop path.

16. The device of claim 13, wherein the first bandwidth occupancy cost factor and the second bandwidth occupancy cost factor are determined using a minimum required bandwidth.

17. The device of claim 13, wherein the first bandwidth occupancy cost factor and the second bandwidth occupancy cost factor are determined using a total available bandwidth.

18. The device of claim 13, wherein the first link metric is a function of the first bandwidth occupancy cost factor and a factor including parameters selected from the following group: a reference packet size; a total transmit time as a function of data rate and packet size; a time spent in back-offs as a result of erroneous transmissions; an average data rate; a packet completion rate; and a scaling factor.

19. The device of claim 13, wherein the first bandwidth occupancy cost factor and the second bandwidth occupancy cost factor are determined according to the following equation:
$$BW\_Occupancy \_Cost \_Factor = [ 1 + \frac{β ( B W - B {W}_{min} )}{B {W}_{band}} ]$$
where BWₘᵢₙ is a minimum required transmission bandwidth; BW is an actual link transmission bandwidth; BW_{band} is a total available bandwidth; and β is a scaling factor.

20. A device for transmitting a data packet from a source node to a destination node in a wireless communication network, comprising:
means for determining a first link metric using a first bandwidth occupancy cost factor for a first multi-hop path between the source node and the destination node;
means for determining a second link metric using a second bandwidth occupancy cost factor for a second multi-hop path between the source node and the destination node;
means for determining whether the first multi-hop path or the second multi-hop path is a preferred path based on a comparison of the first link metric and the second link metric; and
means for transmitting the data packet from the source node to the destination node over the preferred path.
